(19) United States
(12) Patent Application Publication
(10) Pub. No.: US 2016/0208951 A1
(43) Pub. Date: Jul. 21, 2016

(54) HOT RUNNER SYSTEM HAVING MAGNETIC ACTUATORS

(71) Applicant: Otto Männer Innovation GmbH, Bahlingen (DE)

(72) Inventor: Satinder Singh, Botzingen (DE)

(21) Appl. No.: 14/982,399

(22) Filed: Dec. 29, 2015

(30) Foreign Application Priority Data
Jan. 2, 2015 (EP) 15 150 028.7

(51) Int. Cl. F16K 31/08; B29C 45/76; B29C 45/78; B29C 45/23; B29C 45/03; B29C 45/77

(52) U.S. Cl. CPC F16K 31/082; B29C 45/03; B29C 45/77; B29C 45/78; B29C 45/23; B29C 45/7613; B29C 2945/76006; B29C 2945/7604; B29C 2945/7626

(57) ABSTRACT

Magnetic actuator for actuating at least one valve pin of a hot runner system having a moveable actuation plate, first and second permanent magnets, first and second electromagnets which are fastened opposite to the permanent magnets. The magnetic actuator further comprises first and second insulators mounted to the external sides of the electromagnets for preventing magnetic interference with the hot runner system and for reducing heat transfer from the hot runner system to the magnetic actuator.

### CROSS-REFERENCE TO RELATED APPLICATIONS

This application claims benefit of priority from European (EP) Patent Application No. 15 150 028.7, filed Jan. 2, 2015, which is herein incorporated by reference in its entirety.

### TECHNICAL FIELD

This invention is related to a hot runner system for an injection molding apparatus. More specifically, this invention is related to a magnetic actuator for a hot runner system.

### BACKGROUND

Magnetic actuators for hot runner systems are known. In comparison with hydraulic or pneumatic actuators for example no supply bores are needed within the plates and magnetic actuators are suitable for clean-room applications. The known concepts have shortcomings resulting from complex constructions with regard to interfering and/or overlapping magnetic fields as well as to space, easy assembly and servicing.

Therefore, there is a need for an improved magnetic actuator for a hot runner system having a compact design and an easy installation and servicing with reduced influence of generated magnetic fields on the hot runner system.

### SUMMARY

The application proposes a magnetic actuator for actuating at least one valve pin of a hot runner system having a moveable actuation plate arranged to reciprocate in a straight line along the axis (stroke movement) of the at least one valve pin which is mounted with its rear end to the moveable actuation plate, first and second permanent magnets, fastened on top and bottom faces of the actuation plate. First and second electromagnets are fastened opposite to the permanent magnets such, that in an opening position of the at least one valve pin, the first permanent magnet abuts the first electromagnet and in a closing position of the at least one valve pin, the second permanent magnet abuts the second electromagnet. The magnetic actuator further comprises first and second insulators mounted to the external sides of the electromagnets for preventing magnetic interference with the hot runner system and for reducing heat transfer from the hot runner system to the magnetic actuator.

The inventive configuration enables a compact and magnetically shielded design of an actuator: Permanent magnets on both sides of the actuation plate and electromagnets mounted directly vis-à-vis allow an operation whereby one side of the actuation plate is attracted to the corresponding electromagnet and where the other side of the actuation plate is repelled from to the corresponding electromagnet. For moving the actuation plate from a first abutting position in the second abutting position, the directions of the magnetic fields have only to be reversed. Thus the magnetic forces on both sides of the actuation plate at a time are summed up to the resulting moving force of actuation plate and valve pin(s). The inventive configuration allows to use nearly the whole top and bottom face of the actuation plate to be covered with permanent magnets. Thereby a large portion of the extension of the magnetic actuator can be used for the generation of actuation force. Additionally, insulators shield generated magnetic fields thereby reducing problems due to magnetic interference.

The moveable actuation plate is arranged to reciprocate in a straight line along the axis (stroke movement) of at least one valve pin. The leading end of the valve pin extends into a hot runner nozzle (valve gated) and serves for opening and closing of a mold gate to control the flow of melt into a mold cavity. The rear end of the pin is mounted to the moveable actuation plate. Therefore the movement of the valve pin corresponds to the movement of the actuation plate. Within the scope of the invention the actuation plate may have only one valve pin arranged thereon. In the same way it is also possible to have two, three, four, five, six, seven, eight, nine, ten, eleven, twelve or even more valve pins mounted to the actuation plate and moved together with the actuation plate. If more than one valve pin is mounted to an actuation plate, all of these valve pins are moved synchronously.

The magnetic actuator further comprises first and second permanent magnets which are fastened on the top face and on the bottom face of the actuation plate. For applications that require large actuation forces or for applications with very compact design, for example due to enhanced space requirements, the upper and lower faces of the actuation plate may be covered by the permanent magnet. It is also possible to use stronger permanent magnets (or to generate stronger magnetic fields by means of the electromagnet) to further increase the magnetic force in particular for compact designs.

The magnetic actuator further comprises first and second electro-magnets which are fixed opposite to the permanent magnets. In one development the surface of the electromagnets facing the permanent magnets corresponds substantially to the surface of the permanent magnets. The electromagnets are fastened opposite to the permanent magnets such, that in an opening position of the at least one valve pin, the first permanent magnet abuts the first electromagnet. That is, the first permanent magnet is attracted to the first electromagnet and lies against it. For moving the actuation plate to this position the first electromagnet can be charged for generating a magnetic field directed to attract the first permanent magnet.

In the same way, the electromagnets are fastened opposite to the permanent magnets in a way, that in a closing position of the at least one valve pin, the second permanent magnet abuts the second electromagnet. That is, the second permanent magnet is attracted to the second electromagnet and lies against it. For moving the actuation plate in the valve closing position, in the same way the second electromagnet can be charged for generating a magnetic field directed to attract the second permanent magnet.

Moreover it is also possible to charge the first and respectively the second electromagnet for generating a magnetic field directed to repel the respective vis-à-vis permanent magnet from the electromagnet to push the actuation plate to abut against the other electromagnet and thereby to move the actuation plate with the valve pins in the other position to close or open the valve, respectively. The use of magnetic force for moving the actuation plate results in a relatively short shifting time of the valve pins.

The magnetic actuator further comprises first and second insulators mounted to the external sides of the electromagnets for preventing magnetic interference of the magnetic actuator with the hot runner system and for reducing heat transfer from the hot runner system to the magnetic actuator. The external side of the electromagnet is at least the side that faces away from the actuator and the permanent magnet, respectively. The first and second insulators have a design at least sufficient to insulate the generated magnetic field for preventing the magnetic field to influence adjacent plates or other elements of the injection molding machine.

The inventive magnetic actuator thus has a cost effective, easy structured, compact and light weight design, which elements are hardly exposed to wear. Further interactions of the hot runner system with the actuator are prevented by use of insulators.

In a development of the magnetic actuator the first and second permanent magnets are fastened to the actuation plate such that either south poles or north poles are oriented towards the actuation plate. The advantage of such a design is that for operating the actuation plate the electromagnets can be controlled in parallel. By means of a parallel supply with electric current, parallel magnetic fields will be generated by the electromagnets, that is the north and south poles will be directed either to the direction of the mold or to the direction of the machine nozzle. As a result, there is a repelling force between one of the pair of first permanent magnet and first electromagnet and the pair of second permanent magnet and second electromagnet as well as an attracting force between the other pair. Both forces are superimposed for controlling the movement of the actuation plate. This enables higher actuation forces or the use of less strong magnets or magnetic fields, respectively.

In a further development the magnetic actuator is mounted in a recess within the back plate and/or the hot runner back plate. This development is particularly suitable for applications where one valve pin is actuated individually or a smaller number of valve pins (in particular having small distances between each other) are actuated synchronously. A hot runner system may comprise one or a plurality of magnetic actuators. Mounting the magnetic actuator in a recess within plates of the hot runner system gives the magnetic actuator protection against external influences.

In a further development, the at least one valve pin of the magnetic actuator is supported in a valve pin bushing which passes through the second permanent magnet, the second electromagnet and the second insulator. The valve pin bushing supports the valve pin on its way through the second permanent magnet and the second electromagnet when moving between the open and closed position of the valve. In one development, this valve pin bushing extends further into an opening within the hot runner back plate to support the valve pin at a longer distance from the actuation plate. As the valve pin provides a long extension in relation to its cross section, a suitable mounting to the actuation plate as well as a suitable support when moving is important. Therefore the bushing serves for a more robust design of the magnetic actuator.

In a further development of the magnetic actuator at least one service opening is provided for servicing the at least one valve pin. The service opening passes through the first permanent magnet, the first electromagnet and the first insulator. If applicable, it is also appropriate that the service opening also passes through the back plate of the hot runner system. Such a design gives access to the actuation plate through the service opening. For example, if the valve pin is damaged or worn, it can be changed. In the same way, if the at least one valve pin is mounted adjustable with respect to its length at the actuation plate, its extension within the valve and the gate, respectively can be adjusted by use of the service opening.

In a further development the magnetic actuator comprises at least one sensor which in particular monitors the position of the actuator plate and thus of the at least one valve pin. It is also possible to provide further sensors for example to determine the temperature of elements of the actuator.

In a further aspect the invention relates to a magnetic actuator device for actuating at least one valve pin of a hot runner system. The magnetic actuator device comprises a housing which accommodates the magnetic actuator as described above. The magnetic actuator device can be handled easily and mounted as a unit within the hot runner system. Additionally, for example the wiring of the electromagnets can be connected within the housing and guided to a common socket. It is also possible to arrange sensors within the housing for example for monitoring the position of the at least one valve pin. Also the wiring for sensors can be guided to the same or a separate socket which is in particular arranged outside the housing. The arrangement of the elements in a housing also results in compact design. This configuration enables an even more easy installation of the magnetic actuator in a hot runner system.

In a further development of the magnetic actuator device, the housing has at least partially magnetic insulating properties such that at least one of the first and second insulators are integral with the housing. If the insulator is integral with the housing, the electromagnet can be mounted directly to the housing. In a further development, besides magnetic insulating properties, the housing also has at least partially thermal insulating properties for reducing heat transfer from the hot runner system to the magnetic actuator.

A further aspect the invention relates to an injection molding apparatus, comprising at least one magnetic actuator device which is connected to a control device for controlling the actuation of the at least one valve pin. The control device serves for controlling the operation of the valve pins connected to the actuation device. In an injection molding apparatus with more than one magnetic actuator devices this allows for an individual operation of the valve pins connected to each magnetic actuator device. This is in particular advantageous for molds comprising different cavity volumes, shapes or filling geometries (family mold) which require a different control of the filling processes for example due to different duration of the form filling.

By use of the control device it is possible to provide individual closing/opening timing for different cavities or groups of cavities operated by one magnetic actuating device. This invention is in particular applicable for family molds with 64 cavities provided for two different parts (32 cavities for each part). As the form filling process for one part may take longer than for the other part, each actuator can be controlled to open or close at different times. Also an adaption of the time to open/close the valve gate is possible only for the cavities of one part. The invention is in particular advantageous as the provided magnetic actuating device allows for short response times.

A further embodiment of the injection molding apparatus comprises a temperature sensor and/or a pressure sensor arranged in the cavity, in particular at the cavity wall, wherein the sensor is connected to the control device for controlling the actuation of the at least one valve pin. Depending on the type of sensor, its sensing element may for example be placed shortly behind the cavity wall in the mold or it could also replace a portion of the cavity wall. The data provided by a temperature and/or pressure sensor arranged in the cavity gives in particular information regarding the quality and temporal progression of the form filling process and also the solidifying of the melt within the cavity, which also allows to evaluate the quality of the part. With use of the data received from a temperature and/or a pressure sensor the magnetic actuator device may be actuated for opening/closing the valve gate according to the needs of one specific cavity or a group of cavities with valve pins connected to one magnetic actuator device. In the same manner, a magnetic ejection pin actuator can be controlled by using the data received from a temperature sensor and/or a pressure sensor arranged in the cavity.

Further advantages, features and applications of the present invention will become apparent from the following description taken in conjunction with the figures.

### BRIEF DESCRIPTION OF THE DRAWINGS

FIG. 1 shows a sectional view of a hot runner system according to an exemplary embodiment of the invention with the valve pins in a closed position;

FIG. 2a shows the sectional view of FIG. 1 with the valve pins in an open position;

FIG. 2b shows the sectional view of FIG. 1 with the mold in an open position;

FIG. 3a shows a magnetic actuation device of FIG. 1 in more detail; and

FIG. 3b shows a magnetic actuation device of FIG. 2 in more detail.

### DETAILED DESCRIPTION

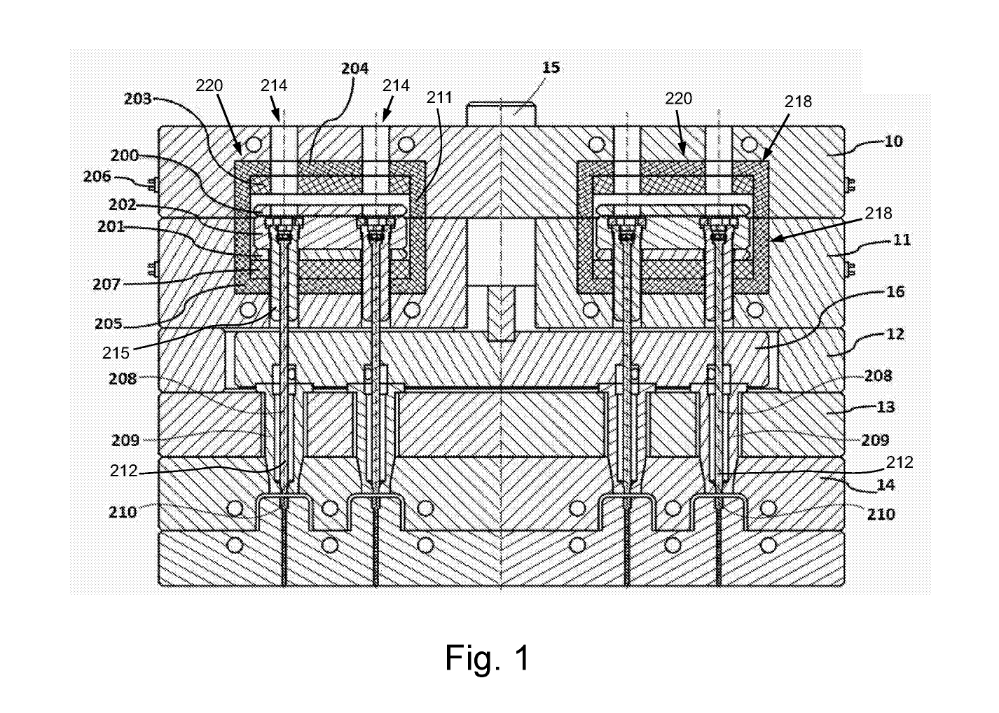

Reference is made to FIG. 1 which shows a sectional view of an exemplary hot runner system according to the invention with the valve pins in a closed position. The system includes a hot runner back plate 11 which is located between a back plate 10 and a hot runner plate 12. Within the hot runner plate 12 a hot runner manifold 16 is arranged. Melt is supplied to the hot runner system through machine nozzle 15. From the machine nozzle 15 the melt is guided (not shown) to the hot runner manifold 16, at which a plurality of hot runner nozzles 209 are arranged. In FIG. 1, four hot runner nozzles 209 are shown, which are partially arranged within the hot runner front plate 13. Each hot runner nozzle 209 has a valve gate which is opened and closed by means of a valve pin 208. If the valve gate is open, the melt from the hot runner manifold 16 can flow through the hot runner nozzle 209 and into a mold cavity, which is arranged in a mold positioned at the cavity plate 14. The melt solidifies within the mold cavity, and thus an injection molded part 210 has been manufactured.

A magnetic actuation device 220 is mounted in a recess 218 which is partially arranged in the back plate 10 and the hot runner back plate 11. The magnetic actuation device 220 includes a moveable (stroke movement) actuation plate 202 with permanent magnets 200, 201) fastened on its top and bottom faces. At the back plate 10, a magnetic insulation 204 which is integral with a housing 211 is mounted between an electromagnet 203 and the back plate 10. In the same way, a magnetic insulation 205 which is integral with the housing 211 is mounted between an electromagnet 207 and the hot runner back plate 11. In the exemplary embodiment, two valve pins 208 are fastened to the actuation plate 202. The valve pins 209 are supported by a valve pin bushing 215, which extends through the permanent magnet 201, the electromagnet 207, the housing 211 and the hot runner back plate 11. The actuation plate 202 is movable between the electromagnets 203, 207 along the valve pin axis 212. In FIG. 1 the actuation plate 202 abuts via permanent magnet 201 the electromagnet 207. In this positon of the actuation plate 202, the valve pins 208 extend into the mold gate and prevent melt to flow into the mold cavities.

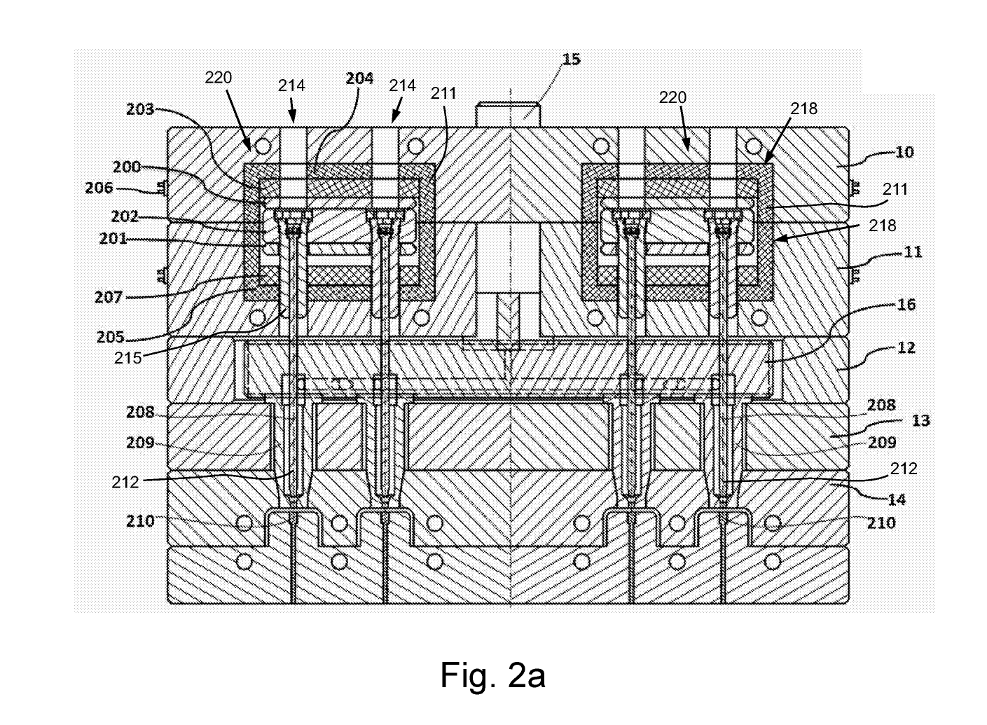

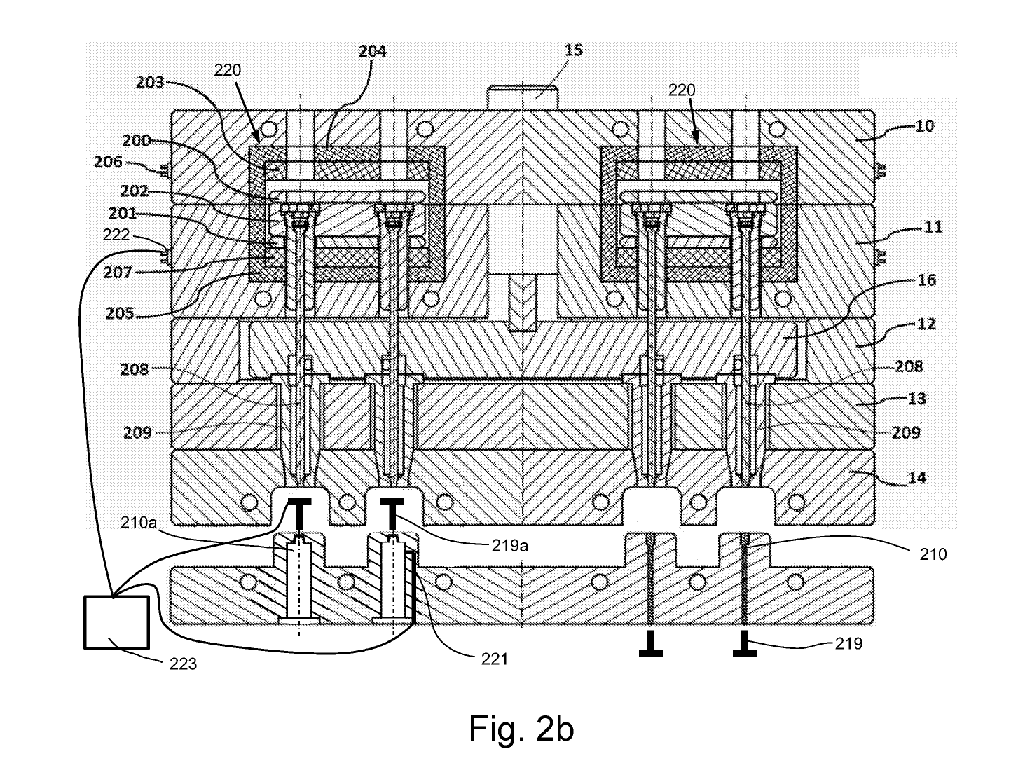

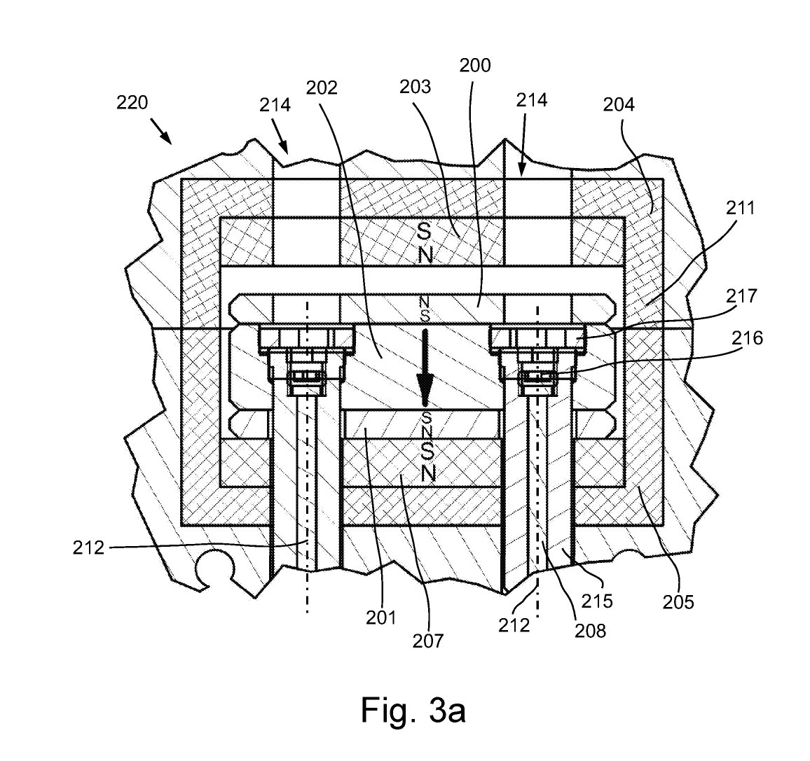

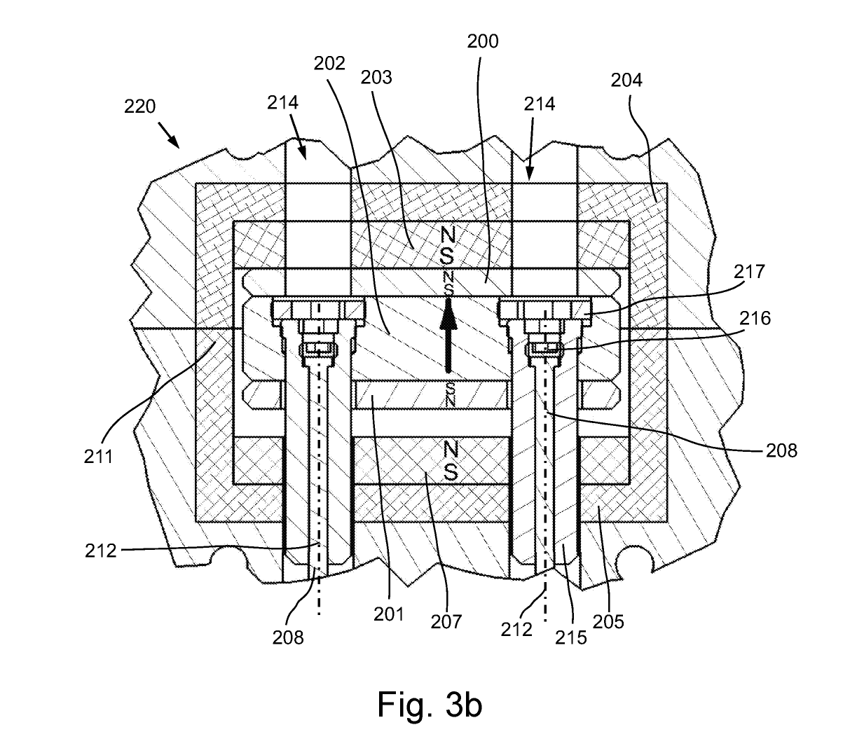

FIG. 2a shows the sectional view of FIG. 1 with the valve pins 208 in an open position. The actuation plate 202 abuts via permanent magnet 200 the electromagnet 203. In this positon of the actuation plate 202, the valve pins 208 are retracted from the mold gate, the melt can flow into the mold cavities. Two service openings 214 are shown at a magnetic actuator device 220 which pass through the back plate 10, the housing 211, the electromagnet 203 and the permanent magnet 200. The valve pin bushing 215 holds the valve pin 208 at its rear side via a grub screw 216. This assembly is fastened to the actuation plate 202 by means of an external thread nut 217. This assembly (shown in more detail in FIGS. 3a and 3b)—in connection with the service opening 214—allows adjusting the valve pin extension at the nozzle tip as well as changing of the valve pin 208.

FIG. 2b shows the sectional view of FIG. 1 with the mold in an open position. Compared with the hot runner system of FIG. 1, the system of FIG. 2b comprises a so called family mold having at least two different types of cavities 210, 210a. The valve pins 208 of each type of cavity 210, 210a are respectively actuated differently by means of one actuation device 220. The illustrated hot runner system is connected to a control device 223, which controls the actuation of the actuation devices 220. For one actuation device 220 a connection to the control device 223 by means of a socket 222 is shown. Also connected to the control device 223 is a combined temperature and sensor pressure 221 which detects data regarding the form filling process and the solidification of the melt within the cavity. Each magnetic actuation device (not shown) of the ejection pins 219, 219a is also connected to and controlled by the control device 223. As the valve pins 208 and the injection pins 219, 219a are actuated by means of magnetic actuators, the hot runner system as shown in FIG. 2b is prepared for use in a clean room environment.

FIGS. 3a and 3b show the magnetic actuation device 220 of the hot runner system of FIGS. 1 and 2 in more detail. The working principle of the magnetic actuator 202 is now illustrated referring to FIGS. 3a and 3b.

Strong permanent magnets 200, 201 are fastened on top and bottom faces of the actuation plate with the same magnetic poles facing outwards, for example in FIG. 3a, 3b the north pole N of both permanent magnets 200, 201 are directed to the outer side of the actuation plate 202. Opposite to the north poles N there are electromagnets 203, 207 attached at a magnetic insulation (shielding) 204, 205 which is integrated in the housing 211. The housing 211 is mounted in a recess 218 (shown in FIGS. 1 and 2) within the back plate 10 and the hot runner back plate 11.

The electromagnets 203, 207 are electrically charged by providing a specific current through socket 206 (shown in FIGS. 1 and 2). In response, the electromagnets 203, 207 generate magnetic fields which result in magnetic north poles N and south poles S at the electromagnets 203, 207. As these electromagnets 203, 207 are arranged opposite to permanent magnets 200, 201, this results in repulsion and attraction of the respective poles and elements, respectively.

The force of the generated magnetic field is proportionate to the electric charge. Therefore, when the direction of the current is reversed, the polarity of the magnetic field is reversed, too. As a result, the effect of the generated forces (repulsion and at-traction) changes accordingly. By increasing the current, more force can be achieved for the actuation of the valve pins 208.

FIGS. 3a and 3b show the repulsion and attraction of actuation plate 202 towards the electromagnets 203, 207. As shown in FIG. 3a, the like poles i.e. north pole N of electromagnet 203 and north pole N of permanent magnet 200 (FIG. 3a) repel each other.

Unlike that, the south pole S of electromagnet 207 attracts the north pole N of permanent magnet 201. This results in the position of the actuation plate 202 in which the valve pin 208 is closed.

FIG. 3b shows the magnetic actuator device 220 after a reversion of the direction of the current. The polarity of the magnetic field of both electromagnets 203, 207 has changed. Now, the north pole N of electromagnet 207 repels the north pole N of permanent magnet 201 and the south pole S of the electromagnet 203 attracts the north pole N of permanent magnet 200. This results in the position of the actuation plate 202 in which the valve pin 208 is open.

Insulators (magnetic shielding) 204, 205 are provided around the magnetic field in order to avoid magnetic interference with elements 10 to 14 and 16 of the hot runner system and other ferromagnetic parts. Such a magnetic interference may in particular result in a loss of magnetic properties. Moreover the insulators 204, 205 of the exemplary embodiment are provided with thermal insulation properties for reducing a heat transfer from hot runner system 16 to the magnetic actuator device 220.

1. A magnetic actuator for actuating at least one valve pin of a hot runner system comprising:
a moveable actuation plate arranged to reciprocate in a straight line along an axis of the at least one valve pin mounted with a rear end to the moveable actuation plate,
first and second permanent magnets fastened on top and bottom faces of the moveable actuation plate,
first and second electromagnets fastened opposite to the permanent magnets such, that in an opening position of the at least one valve pin, the first permanent magnet abuts the first electromagnet, and in a closing position of the at least one valve pin, the second permanent magnet abuts the second electromagnet, and
first and second insulators mounted to the external sides of the electromagnets for preventing magnetic interference with the hot runner system and for reducing heat transfer from the hot runner system to the magnetic actuator.

2. The magnetic actuator according to claim 1, characterized in that the first and second permanent magnets are fastened to the moveable actuation plate such, that either south poles (S) or north poles (N) of the permanent magnets are oriented towards the moveable actuation plate.

3. The magnetic actuator according to claim 1, characterized in that the magnetic actuator is mounted in a recess within a back plate.

4. The magnetic actuator according to claim 3, wherein the back plate is a hot runner back plate.

5. The magnetic actuator according to claim 1, characterized in that the at least one valve pin is supported in at least one valve pin bushing which passes through the second permanent magnet, the second electromagnet, and the second insulator.

6. The magnetic actuator according to claim 5, characterized in that the at least one valve pin bushing extends into an opening within a hot runner back plate.

7. The magnetic actuator according to claim 1, characterized in that at least one service opening is provided for servicing the at least one valve pin, wherein the service opening passes through the first permanent magnet, the first electromagnet, and the first insulator.

8. The magnetic actuator according to claim 7, characterized in that the at least one service opening passes through a back plate.

9. The magnetic actuator according to claim 1, characterized in that at least four valve pins are mounted to the moveable actuation plate.

10. The magnetic actuator according to claim 1, further comprising at least one sensor for monitoring the position of the at least one valve pin.

11. A magnetic actuator device for actuating at least one valve pin of a hot runner system having a housing, characterized in that the housing accommodates the magnetic actuator of claim 1.

12. The magnetic actuator device according to claim 11, characterized in that the housing has at least partially magnetic insulating properties such that at least one of the first and second insulators are integral with the housing.

13. The magnetic actuator device according to claim 12, characterized in that the housing has at least partially thermal insulating properties.

14. An injection molding apparatus, comprising a cavity and at least one magnetic actuator device of claim 10 connected to a control device for controlling the actuation of the at least one valve pin.

15. An injection molding apparatus according to claim 14, further comprising a temperature sensor arranged in the cavity and connected to the control device for controlling the actuation of the at least one valve pin.

16. An injection molding apparatus according to claim 14, further comprising a pressure sensor arranged in the cavity and connected to the control device for controlling the actuation of the at least one valve pin.

17. An injection molding apparatus according to claim 14, further comprising a combined temperature and pressure sensor arranged in the cavity and connected to the control device for controlling the actuation of the at least one valve pin.
